(19) United States
(12) Patent Application Publication
(10) Pub. No.: US 2025/0198522 A1
(43) Pub. Date: Jun. 19, 2025

(54) FLUID EQUIPMENT SYSTEM

(71) Applicant: Surpass Industry Co. Ltd., Saitama (JP)

(72) Inventor: Atsushi INOUE, Saitama (JP)

(21) Appl. No.: 18/969,716

(22) Filed: Dec. 5, 2024

(30) Foreign Application Priority Data
Dec. 15, 2023 (JP) 2023-212261

(51) Int. Cl. F16K 11/20; F16K 27/00

(52) U.S. Cl. CPC F16K 11/20; F16K 27/003

(57) ABSTRACT

Provided is a fluid equipment system including: a flow path member; a first valve installed in a first region; a second valve installed in a second region; and a third valve installed in a third region and configured to switch the inflow state of a fluid from a third flow path into a second flow path, a first flow path guides a fluid flowing in from the inflow port to a first outflow port, the second flow path guides a fluid flowing in from the third valve to a second outflow port, the third flow path guides a fluid flowing in from the first flow path to the third outflow port, and the inflow port is connected to a flow rate adjustment device and opened to a fourth region that matches the third region in first directions and matches the first region in second directions.

### CROSS-REFERENCE TO RELATED APPLICATIONS

This application claims foreign priority benefits under U.S.C. § 119 to Japanese Patent Application No. 2023-212261 filed on Dec. 15, 2023, the contents of which is hereby incorporated by reference in its entirety.

### BACKGROUND

### 1. Technical Field

The present disclosure relates to a fluid equipment system.

### 2. Description of Related Art

Fluid equipment in which a fluid supplied from a source to an inflow port is discharged to any of a plurality of outflow ports is conventionally known. Fluid equipment disclosed in Japanese Patent Application Laid-Open No. 2017-2919 has a first fluid unit having a plurality of first flow paths that allow a fluid to flow in a first direction and a second fluid unit having a plurality of second flow paths that allow a fluid to flow in a second direction orthogonal to the first direction, and a plurality of on-off valves are arranged to a plurality of positions, respectively, at which the plurality of first flow paths and the plurality of second flow paths intersect with each other.

The fluid equipment disclosed in Japanese Patent Application Laid-Open No. 2017-2919 can discharge a fluid that has flown into the plurality of first flow paths, which allow the fluid to flow in the first direction, out of a desired second flow path, which allows the fluid to flow in the second direction orthogonal to the first direction, by switching the open/close state of the plurality of on-off valves.

In the fluid equipment disclosed in Japanese Patent Application Laid-Open No. 2017-2919, however, since the positions in the first direction at which the plurality of second flow paths are arranged differ from each other, the size in the first direction of the fluid equipment will be increased in accordance with the number of discharge ports where the fluid is discharged out of the second flow path. In the example illustrated in FIG. 1, to provide five discharge ports of the second fluid unit, it is required to arrange second flow path members for five lines, and this will increase the size of the fluid equipment.

The present disclosure has been made in view of such circumstances and intends to reduce the size of a fluid equipment system that allows a fluid flowing in from an inflow port to be selectively guided to a plurality of outflow ports.

### BRIEF SUMMARY

The present disclosure employs the following solutions in order to achieve the object described above.

A fluid equipment system according to the first aspect of the present disclosure includes: a flow path member installed to an installation face; a first valve installed in a first region of the flow path member when the installation face is viewed in planar view and configured to switch a flow state of a fluid flowing through a first flow path; a second valve installed in a second region of the flow path member when the installation face is viewed in planar view and configured to switch a flow state of a fluid flowing through a second flow path; a third valve installed in a third region of the flow path member when the installation face is viewed in planar view and configured to switch an inflow state of a fluid from a third flow path into the second flow path; and fluid equipment configured to supply a fluid to the flow path member. The second region is a region that matches the first region in first directions parallel to the installation face and is adjacent to the first region in second directions parallel to the installation face and orthogonal to the first directions, and the third region is a region that is adjacent to the second region in the first directions and matches the second region in the second directions. In the first region, an inflow port, a fluid flowing from the fluid equipment into the inflow port, and a first outflow port configured to allow a fluid flowing in from the inflow port to flow out to outside are formed. In the second region, a second outflow port configured to allow a fluid to flow out to outside is formed. In the third region, a third outflow port configured to allow a fluid to flow out to outside is formed. The first flow path is formed in the first region so that a fluid flowing in from the inflow port is guided to the first outflow port via the first valve, the second flow path is formed in the second region and the third region so that a fluid flowing in from the third valve is guided to the second outflow port via the second valve, the third flow path is formed in the first region, the second region, and the third region so that a fluid flowing in from the first flow path is guided to the third outflow port, and the inflow port is connected to the fluid equipment and opened to a fourth region that matches the third region in the first directions and matches the first region in the second directions.

According to the fluid equipment system of the first aspect of the present disclosure, a fluid flows in a first direction into the inflow port formed in the first region of the flow path member. Further, a fluid flows out in the first direction from the first outflow port formed in the first region of the flow path member, the second outflow port formed in the second region of the flow path member, and the third outflow port formed in the third region of the flow path member. Since both the direction in which a fluid flows into the flow path member and the direction in which the fluid flows out of the flow path member are the same direction, the size of the fluid equipment system can be reduced compared to a case where these directions differ from each other.

Further, the inflow port is connected to the fluid equipment and opened to a fourth region that matches the third region in the first directions and matches the first region in the second directions. Since the fluid equipment connected to the inflow port and the flow path member can be connected in the fourth region, the size of the fluid equipment system can be reduced.

The fluid equipment system according to the second aspect of the present disclosure is further configured as follows in the first aspect. That is, the first valve switches the flow state between a first outflow state where a fluid flows from the inflow port to the first outflow port and a first shutoff state where no fluid flows from the inflow port to the first outflow port, the second valve switches the flow state between a second outflow state where a fluid flows from the third flow path to the second outflow port and a second shutoff state where no fluid flows from the third flow path to the second outflow port, and the third valve adjusts a flow rate of a fluid flowing from the third flow path to the second flow path in the second outflow state.

According to the fluid equipment system of the second aspect of the present disclosure, the first outflow state where a fluid flows out of the first outflow port and the first shutoff state where no fluid flows out of the first outflow port can be switched by the first valve. Further, the second outflow state where a fluid flows out of the second outflow port and the second shutoff state where no fluid flows out of the second outflow port can be switched by the second valve. Furthermore, the flow rate of a fluid flowing from the third flow path into the second flow path can be adjusted by the third valve in the second outflow state.

The fluid equipment system according to the third aspect of the present disclosure is further configured as follows in the first aspect or the second aspect. That is, the third flow path is arranged lower in a vertical direction than the second flow path in the second region.

According to the fluid equipment system of the third aspect of the present disclosure, since the third flow path is arranged lower in the vertical direction than the second flow path in the second region, the second flow path and the third flow path can be suitably arranged without interference with each other in the second region of the flow path member.

A fluid equipment system according to the fourth aspect of the present disclosure includes: a flow path member installed to an installation face; a first valve installed in a first region of the flow path member when the installation face is viewed in planar view and configured to switch an inflow state of a fluid from a first flow path into a second flow path; a second valve installed in a second region of the flow path member when the installation face is viewed in planar view and configured to switch a flow state of a fluid flowing through the second flow path; a third valve installed in a third region of the flow path member when the installation face is viewed in planar view and configured to switch an inflow state of a fluid from a third flow path into a fourth flow path; and a fourth valve installed in a fourth region of the flow path member when the installation face is viewed in planar view and configured to switch a flow state of a fluid flowing through the fourth flow path. The second region is a region that is adjacent to the first region in first directions parallel to the installation face and matches the first region in second directions parallel to the installation face and orthogonal to the first directions, the third region is a region that matches the first region in the first directions and is adjacent to the first region in the second directions, and the fourth region is a region that matches the second region in the first directions and matches the third region in the second directions. In the first region, a first inflow port, a fluid flowing into the first inflow port, and a first outflow port configured to allow a fluid flowing in from the first inflow port to flow out in one direction of the first directions to outside are formed. In the second region, a second inflow port, a fluid flowing into the second inflow port, and a second outflow port configured to allow a fluid to flow out in the other direction of the first directions to outside are formed. In the third region, a third outflow port configured to allow a fluid to flow out in the one direction of the first directions to outside is formed. In the fourth region, a fourth outflow port configured to allow a fluid to flow out in the other direction of the first directions to outside is formed. The first flow path is formed in the first region so that a fluid flowing in from the first inflow port is guided to the first outflow port, the second flow path is formed in the first region and the second region so that a fluid flowing in from the first valve is guided to the second outflow port via the second valve, the third flow path is formed in the second region, the third region, and the fourth region so that a fluid flowing in from the second inflow port is guided to the third outflow port, and the fourth flow path is formed in the third region and the fourth region so that a fluid flowing in from the third valve is guided to the fourth outflow port via the fourth valve.

According to the fluid equipment system of the fourth aspect of the present disclosure, since the first valve, the second valve, the third valve, and the fourth valve are arranged in four adjacent regions, namely, the first region, the second region, the third region, and the fourth region, respectively, the size of the fluid equipment system can be reduced compared to a case where some of these valves are arranged in non-adjacent regions.

Further, according to the fluid equipment system of the fourth aspect of the present disclosure, a fluid flows out in one direction of the first directions from the first outflow port formed in the first region of the flow path member and from the third outflow port formed in the third region of the flow path member, and a fluid flows out in the other direction of the first directions from the second outflow port formed in the second region of the flow path member and from the fourth outflow port formed in the fourth region of the flow path member. Respective outflow directions in which the fluids flow out of the flow path member are the first directions but are divided into one direction and the other direction. Thus, the size of the fluid equipment system can be reduced compared to a case where these outflow directions differ from each other or the outflow occurs only in one direction or the other direction.

The fluid equipment system according to the fifth aspect of the present disclosure is further configured as follows in the fourth aspect. That is, the first valve adjusts the flow rate of a fluid flowing from the first flow path into the second flow path, the second valve switches the flow state between a state where a fluid flows out of the second outflow port and a state where no fluid flows out of the second outflow port, the third valve adjusts the flow rate of a fluid flowing from the third flow path into the fourth flow path, and the fourth valve switches the flow state between a state where a fluid flows out of the fourth outflow port and a state where no fluid flows out of the fourth outflow port.

According to the fluid equipment system of the fifth aspect of the present disclosure, the flow rate of a fluid flowing from the first flow path into the second flow path can be adjusted by the first valve. Further, the state where a fluid flows out of the second outflow port and the state where no fluid flows out of the second outflow port can be switched by the second valve. Further, the flow rate of a fluid flowing from the third flow path into the fourth flow path can be adjusted by the third valve. Further, the state where a fluid flows out of the fourth outflow port and the state where no fluid flows out of the fourth outflow port can be switched by the fourth valve.

The fluid equipment system according to the sixth aspect of the present disclosure is further configured as follows in the fourth aspect or the fifth aspect. That is, the third flow path is arranged lower in a vertical direction than the fourth flow path in the fourth region.

According to the fluid equipment system of the sixth aspect of the present disclosure, since the third flow path is arranged lower in the vertical direction than the fourth flow path in the fourth region, the third flow path and the fourth flow path can be suitably arranged without interference with each other in the fourth region of the flow path member.

According to the present disclosure, it is possible to reduce the size of a fluid equipment system that allows a fluid flowing in from an inflow port to be selectively guided to a plurality of outflow ports.

### BRIEF DESCRIPTION OF THE SEVERAL VIEWS OF THE DRAWINGS

FIG. 1 is a plan view illustrating a fluid equipment system of a first embodiment of the present disclosure.

FIG. 2 is a schematic configuration diagram illustrating the fluid equipment system of the first embodiment of the present disclosure.

FIG. 3 is an arrow A-A sectional view of the fluid equipment system illustrated in FIG. 1.

FIG. 4 is an arrow B-B sectional view of the fluid equipment system illustrated in FIG. 1.

FIG. 5 is an arrow C-C sectional view of the fluid equipment system illustrated in FIG. 1.

FIG. 6 is a plan view of a flow path member illustrated in FIG. 1.

FIG. 7 is a plan view illustrating a fluid equipment system of a second embodiment of the present disclosure.

FIG. 8 is a schematic configuration diagram illustrating the fluid equipment system of the second embodiment of the present disclosure.

FIG. 9 is an arrow D-D sectional view of the fluid equipment system illustrated in FIG. 7.

FIG. 10 is an arrow E-E sectional view of the fluid equipment system illustrated in FIG. 7.

FIG. 11 is an arrow F-F sectional view of the fluid equipment system illustrated in FIG. 7.

FIG. 12 is an arrow G-G sectional view of the fluid equipment system illustrated in FIG. 7.

FIG. 13 is a plan view of a flow path member illustrated in FIG. 7.

FIG. 14 is a plan view illustrating a modified example for the flow path member of the second embodiment of the present disclosure.

### DETAILED DESCRIPTION

### First Embodiment

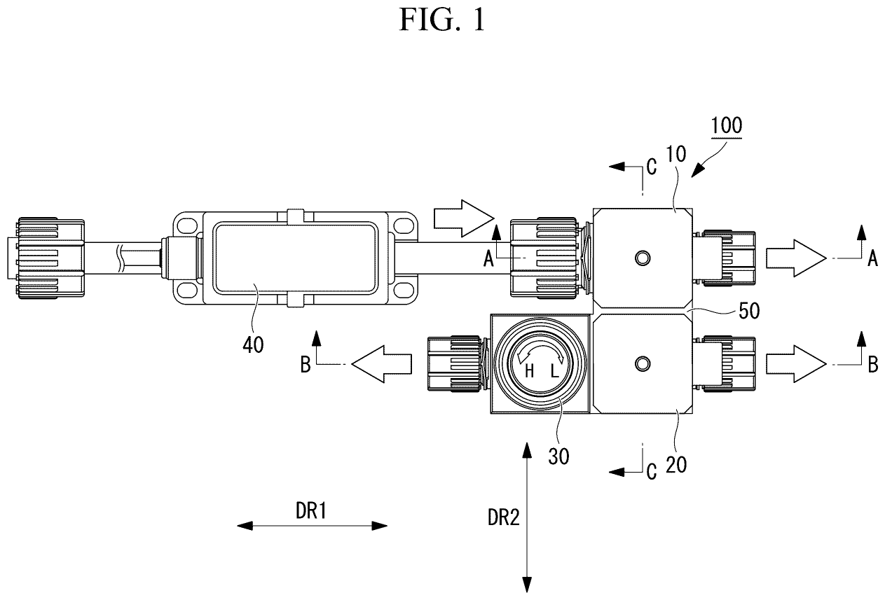

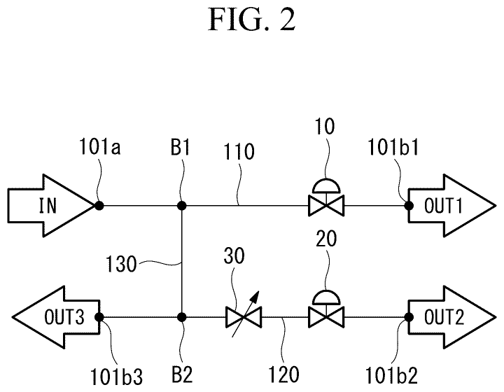

A fluid equipment system 100 of the first embodiment of the present disclosure will be described below with reference to the drawings. FIG. 1 is a plan view illustrating the fluid equipment system 100 of one embodiment of the present disclosure. FIG. 2 is a schematic configuration diagram illustrating the fluid equipment system 100 of the first embodiment of the present disclosure.

As illustrated in FIG. 1, the fluid equipment system 100 of the present embodiment includes a first valve 10, a second valve 20, a third valve 30, a flow rate adjustment device (fluid equipment) 40, and a flow path member 50.

As illustrated in FIG. 2, the fluid equipment system 100 of the present embodiment is a device that can allow a fluid (pure water or a chemical solution such as hydrofluoric acid) supplied from the flow rate adjustment device 40 to an inflow port 101a to flow out of at least any of a first outflow port 101b1, a second outflow port 101b2, and a third outflow port 101b3.

The first valve 10 is a shutoff valve that switches the flow state of a fluid flowing through a first flow path 110. As illustrated in FIG. 2, the first flow path 110 is a flow path that allows a fluid to flow from the inflow port 101a to the first outflow port 101b1 via a branch position B1.

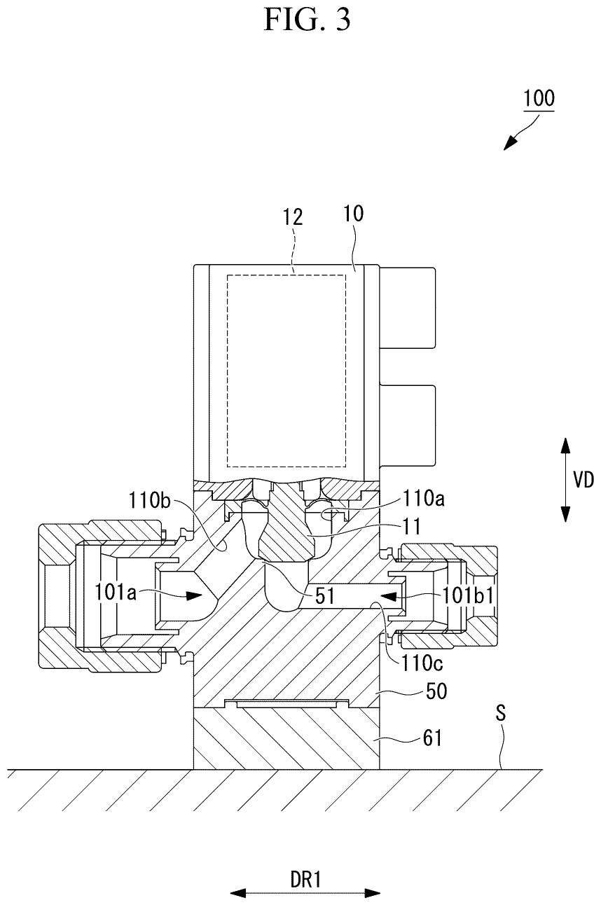

FIG. 3 is an arrow A-A sectional view of the fluid equipment system illustrated in FIG. 1. As illustrated in FIG. 3, the first valve 10 has a switching mechanism 12 that causes a valve disc 11 to come into contact with or separate from a valve seat 51 of the flow path member 50 along vertical directions VD and thereby switches the flow state between a first outflow state where a fluid flows from the inflow port 101a to the first outflow port 101b1 and a first shutoff state where no fluid flows from the inflow port 101a to the first outflow port 101b1.

The second valve 20 is a shutoff valve that switches the flow state of a fluid flowing through a second flow path 120. As illustrated in FIG. 2, the second flow path 120 is a flow path that allows a fluid to flow from a branch position B2 to the second outflow port 101b2.

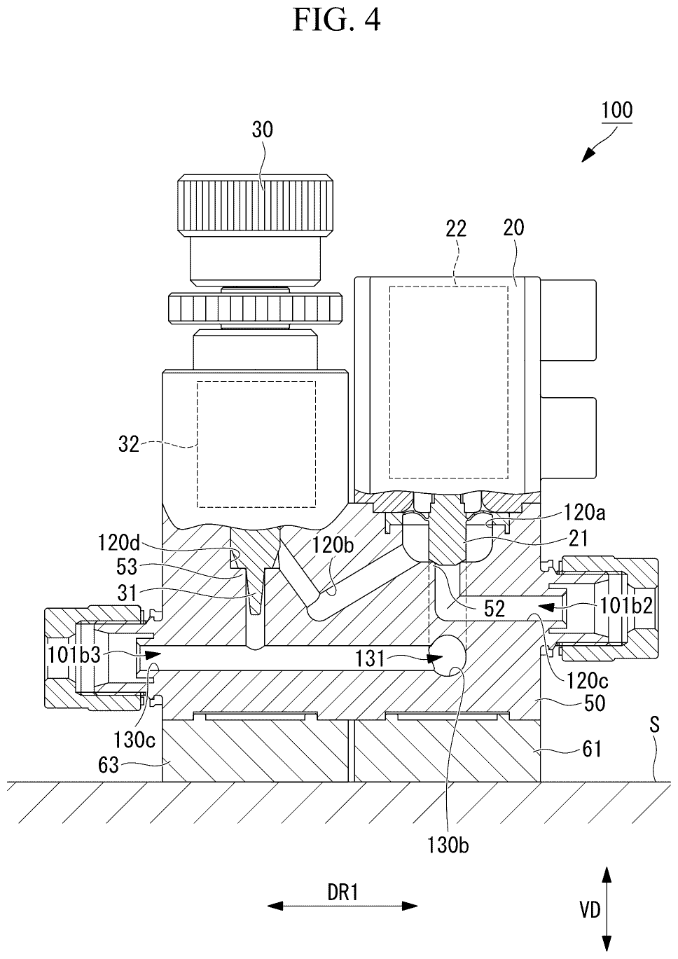

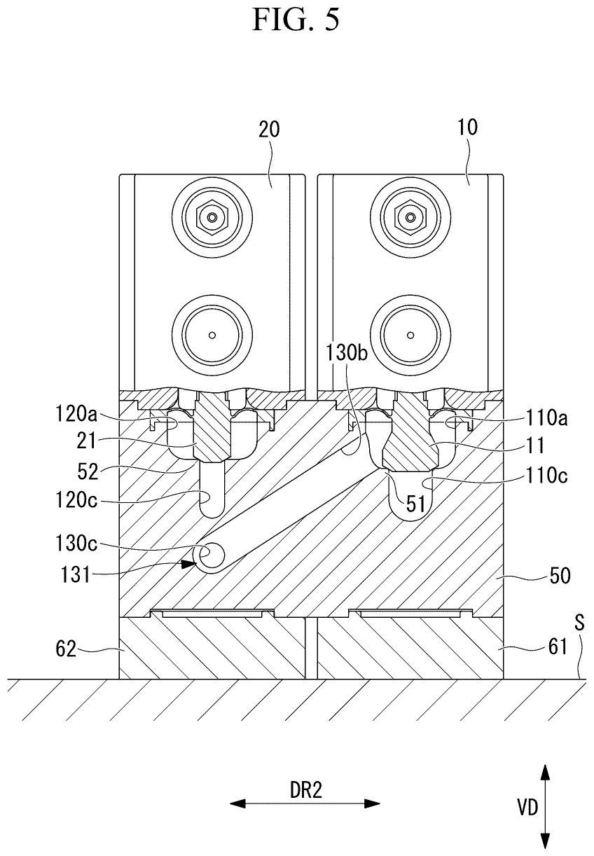

FIG. 4 is an arrow B-B sectional view of the fluid equipment system illustrated in FIG. 1. FIG. 5 is an arrow C-C sectional view of the fluid equipment system 100 illustrated in FIG. 1. As illustrated in FIG. 4 and FIG. 5, the second valve 20 has a switching mechanism 22 that causes a valve disc 21 to come into contact with or separate from a valve seat 52 of the flow path member 50 along the vertical directions VD and thereby switches the flow state between a second outflow state where a fluid flows from the third flow path 130 to the second outflow port 101b2 via the second flow path 120 and a second shutoff state where no fluid flows from the third flow path 130 to the second outflow port 101b2 via the second flow path 120.

The third valve 30 is a flow rate adjustment valve that switches an inflow state of a fluid from the third flow path 130 to the second flow path 120. As illustrated in FIG. 2, the third flow path 130 is a flow path that allows a fluid to flow from the branch position B1 to the third outflow port 101b3 via the branch position B2.

As illustrated in FIG. 4, the third valve 30 has an adjustment mechanism 32 that adjusts a flow rate of a fluid flowing from the third flow path 130 into the second flow path 120 in the second outflow state where a fluid flows from the third flow path 130 to the second outflow port 101b2 via the second flow path 120. The adjustment mechanism 32 causes a valve disc 31 to come close to or separate from a valve seat 53 of the flow path member 50 along the vertical directions VD and thereby adjusts the flow rate of a fluid flowing from the third flow path 130 into the second flow path 120.

The flow rate adjustment device 40 is a device that adjusts an inflow amount of a fluid flowing into the inflow port 101a of the flow path member 50. The flow rate adjustment device 40 has a flow rate measuring part (not illustrated) and a flow rate adjustment part (not illustrated). The flow rate adjustment device 40 controls the flow rate adjustment part so that the flow rate measured by the flow rate measuring part matches a set flow rate set in advance. The flow rate adjustment device 40 supplies a fluid at the set flow rate set in advance to the inflow port 101a of the flow path member 50. Note that, instead of the flow rate adjustment device 40, a flowmeter having only the flow rate measuring part without having the flow rate adjustment part may be installed.

The fluid equipment system 100 of the present embodiment switches the first valve 10 to determine whether or not to allow a fluid flowing into the inflow port 101a to flow out of the first outflow port 101b1, switches the second valve 20 to determine whether or not to allow a fluid flowing into the inflow port 101a to flow out of the second outflow port 101b2, and causes the third valve 30 to adjust the flow rate of a fluid allowed to flow out of the second outflow port 101b2. The fluid equipment system 100 can cause the flow rate adjustment device 40 to supply a fluid at a set flow rate set in advance to the first outflow port 101b1, the second outflow port 101b2, and the third outflow port 101b3 at respective desired flow rates.

The flow path member 50 is a member installed to the installation face S via base members 61, 62, 63. The flow path member 50 is formed of, for example, a fluoroplastic material. As illustrated in FIG. 3 and FIG. 5, the flow path member 50 is arranged interposed between the base member 61 and the first valve 10. As illustrated in FIG. 4 and FIG. 5, the flow path member 50 is arranged interposed between the base member 62 and the second valve 20. As illustrated in FIG. 4, the flow path member 50 is arranged interposed between the base member 63 and the third valve 30.

The base members 61, 62, 63 are fixed to the installation face S by fastening bolts (not illustrated), respectively. Further, the flow path member 50 is fixed to the base members 61, 62, 63 by fastening bolts (not illustrated), respectively.

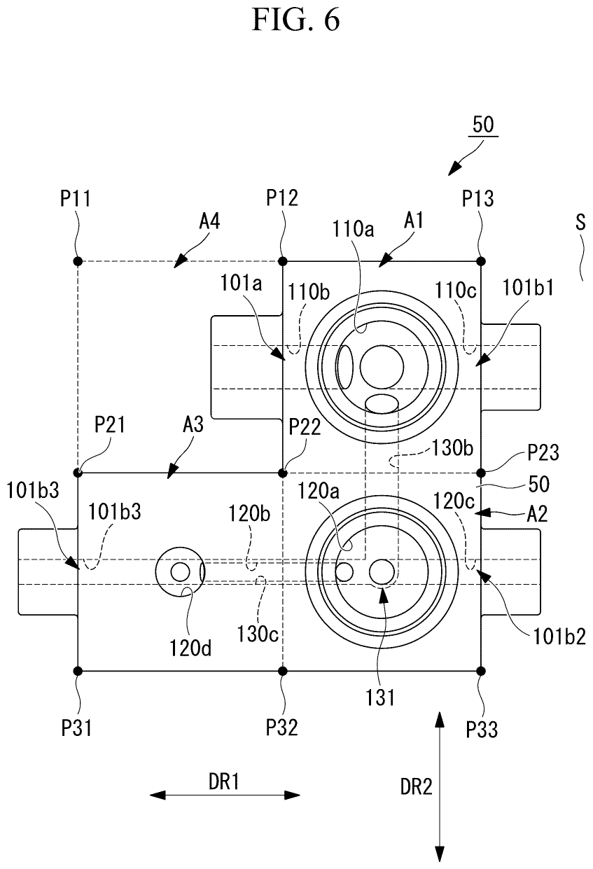

FIG. 6 is a plan view of the flow path member 50 illustrated in FIG. 1. As illustrated in FIG. 6, the flow path member 50 has a first region A1 in which the first valve 10 is installed, a second region A2 in which the second valve 20 is installed, and a third region A3 in which the third valve 30 is installed when the installation face S is viewed in planar view. The first region A1 is a rectangular region having vertexes of position P12, position P13, position P22, and position P23. The second region A2 is a rectangular region having vertexes of position P22, position P23, position P32, and position P33. The third region A3 is a rectangular region having vertexes of position P21, position P22, position P31, and position P32.

As illustrated in FIG. 6, the second region A2 is a region that matches the first region A1 in first directions DR1 (bidirectional) parallel to the installation face S and is adjacent to the first region A1 in second directions DR2 (bidirectional) parallel to the installation face S and orthogonal to the first directions DR1. The third region A3 is a region that is adjacent to the second region A2 in the first directions DR1 and matches the second region A2 in the second directions DR2.

In the first region A1, the inflow port 101a into which a fluid flows in a first direction DR1 from the flow rate adjustment device 40 and the first outflow port 101b1 which allows a fluid flowing in from the inflow port 101a to flow out in the first direction DR1 to outside are formed. The inflow port 101a is connected to the flow rate adjustment device 40 and opened toward a fourth region A4.

The fourth region A4 is a region that matches the third region A3 in the first directions DR1 and matches the first region A1 in the second directions DR2. The fourth region A4 is a rectangular region having vertexes of position P11, position P12, position P21, and position P22.

In the second region A2, the second outflow port 101b2 that allows a fluid to flow out in the first direction DR1 to outside is formed. In the third region A3, the third outflow port 101b3 that allows a fluid to flow out in the first direction DR1 to outside is formed.

The first flow path 110 is formed in the first region A1 so that a fluid flowing in from the inflow port 101a is guided to the first outflow port 101b1 via the first valve 10. The first flow path 110 has a valve chest 110a in which the valve disc 11 of the first valve 10 is accommodated, an inflow flow path 110b which allows the inflow port 101a and the valve chest 110a to communicate with each other, and an outflow flow path 110c which allows the valve chest 110a and the first outflow port 101b1 to communicate with each other.

The second flow path 120 is formed in the second region A2 and the third region A3 so that a fluid flowing in from the third valve 30 is guided to the second outflow port 101b2 via the second valve 20. The second flow path 120 has a valve chest 120a in which the valve disc 21 of the second valve 20 is accommodated, an inflow flow path 120b which allows a valve chest 120d of the third valve 30 and the valve chest 120a to communicate with each other, an outflow flow path 120c which allows the valve chest 120a and the second outflow port 101b2 to communicate with each other, and a valve chest 120d in which a valve disc 31 of the third valve 30 is accommodated.

The third flow path 130 is formed in the first region A1, the second region A2, and the third region A3 so that a fluid flowing in from the first flow path 110 is guided to the third outflow port 101b3. The third flow path 130 has a connection flow path 130b that allows the valve chest 110a and a connection part 131 below the valve chest 120a to communicate with each other and an outflow flow path 130c that allows the connection part 131 and the third outflow port 101b3 to communicate with each other. The third flow path 130 is arranged lower in the vertical direction VD than the outflow flow path 120c of the second flow path 120 in the second region A2.

The effects and advantages achieved by the fluid equipment system 100 of the present embodiment described above will be described.

According to the fluid equipment system 100 of the present embodiment, a fluid flows into the inflow port 101a formed in the first region A1 of the flow path member 50. Further, a fluid flows out in a second direction DR2 orthogonal to the first direction DR1 from the first outflow port 101b1 formed in the first region A1 of the flow path member 50, from the second outflow port 101b2 formed in the second region A2 of the flow path member 50, and from the third outflow port 101b3 formed in the third region A3 of the flow path member 50. Since both the direction in which a fluid flows into the flow path member 50 and the directions in which the fluid flows out of the flow path member 50 are the same direction, the size of the fluid equipment system 100 can be reduced compared to a case where these directions differ from each other.

Further, the inflow port 101a is connected to the flow rate adjustment device 40 and opened to the fourth region A4 that matches the third region A3 in the first directions DR1 and matches the first region A1 in the second directions DR2. Since the flow rate adjustment device 40 connected to the inflow port 101a and the flow path member 50 can be connected in the fourth region A4, the size of the fluid equipment system 100 can be reduced.

### Second Embodiment

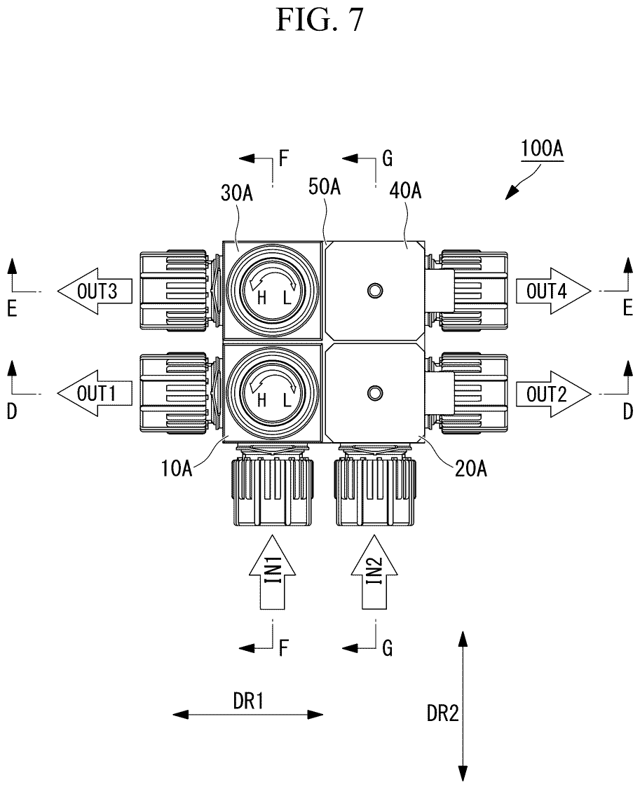

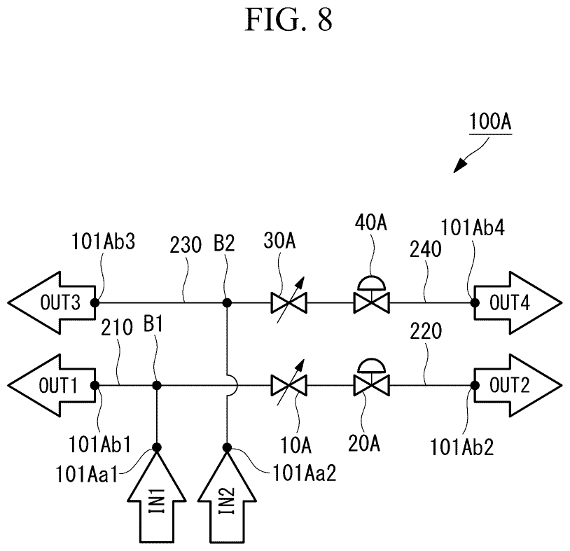

A fluid equipment system 100A of the second embodiment of the present disclosure will be described below with reference to the drawings. FIG. 7 is a plan view illustrating the fluid equipment system 100A of the second embodiment of the present disclosure. FIG. 8 is a schematic configuration diagram illustrating the fluid equipment system 100A of the second embodiment of the present disclosure.

The fluid equipment system 100 of the first embodiment is to allow a fluid flowing from the single inflow port 101a into the flow path member 50 to flow out of the three outflow ports, namely, the first outflow port 101b1, the second outflow port 101b2, and the third outflow port 101b3. In contrast, the fluid equipment system 100A of the present embodiment is to allow a fluid flowing from a first inflow port 101Aa1 into a flow path member 50A to flow out of a first outflow port 101Ab1 and a second outflow port 101Ab2 and allow a fluid flowing from a second inflow port 101Aa2 into the flow path member 50A to flow out of a third outflow port 101Ab3 and a fourth outflow port 101Ab4.

As illustrated in FIG. 7, the fluid equipment system 100A of the present embodiment includes a first valve 10A, a second valve 20A, a third valve 30A, a fourth valve 40A, and the flow path member 50A.

As illustrated in FIG. 8, the fluid equipment system 100A of the present embodiment is a device that can allow a fluid (pure water or a chemical solution such as hydrofluoric acid) supplied to a first inflow port 101Aa1 to flow out of at least any of a first outflow port 101Ab1 and a second outflow port 101Ab2 and allow a fluid supplied to a second inflow port 101Aa2 to flow out of at least any of a third outflow port 101Ab3 and a fourth outflow port 101Ab4.

The first valve 10A is a flow rate adjustment valve that switches the inflow state of a fluid flowing from a first flow path 210 to a second flow path 220. As illustrated in FIG. 8, the first flow path 210 is a flow path that allows a fluid to flow from the first inflow port 101Aa1 to the first outflow port 101Ab1 via the branch position B1.

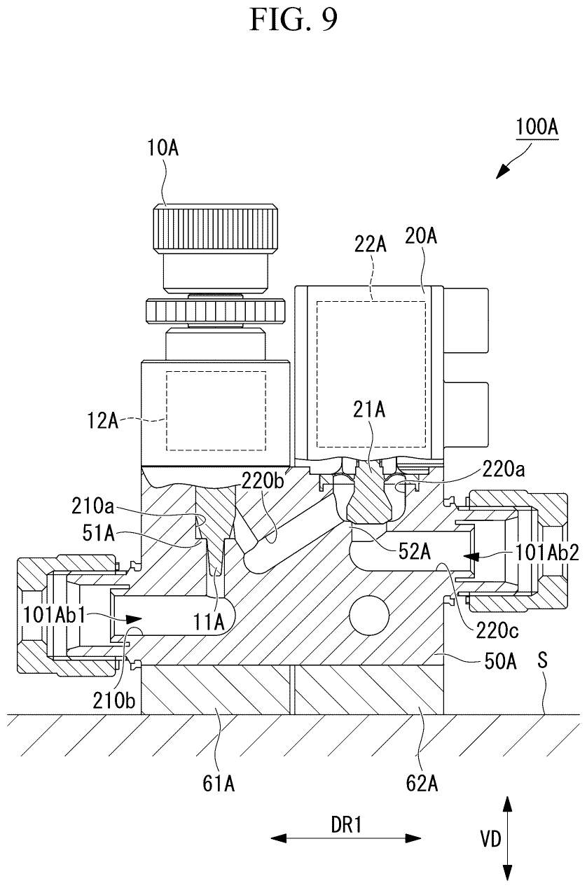

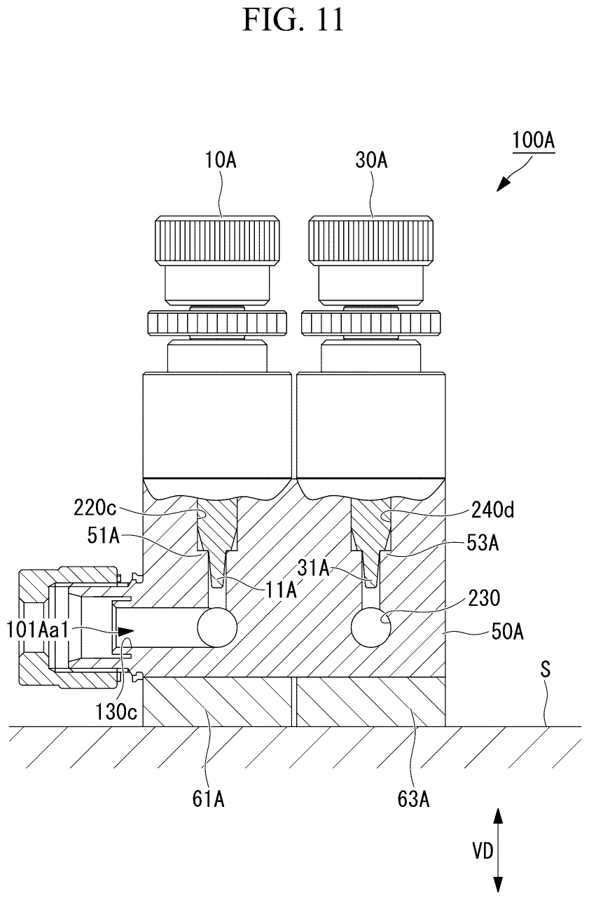

FIG. 9 is an arrow D-D sectional view of the fluid equipment system 100A illustrated in FIG. 7. FIG. 11 is an arrow F-F sectional view of the fluid equipment system 100A illustrated in FIG. 7. As illustrated in FIG. 9 and FIG. 11, the first valve 10A has an adjustment mechanism 12A that adjusts the flow rate of a fluid flowing from the first flow path 210 into the second flow path 220. The adjustment mechanism 12A causes a valve disc 11A to come close to or separate from a valve seat 51A of the flow path member 50A along the vertical directions VD and thereby adjusts the flow rate of a fluid flowing from the first flow path 210 into the second flow path 220.

The second valve 20A is a shutoff valve that switches the flow state of a fluid flowing through the second flow path 220. As illustrated in FIG. 8, the second flow path 220 is a flow path that allows a fluid to flow from the branch position B1 to the second outflow port 101Ab2 via the first valve 10A and the second valve 20A.

As illustrated in FIG. 9, the second valve 20A has a switching mechanism 22A that causes a valve disc 21A to come into contact with or separate from a valve seat 52A of the flow path member 50A along the vertical directions VD and thereby switches the flow state between a flow-through state where a fluid flows from the first flow path 210 to the second outflow port 101Ab2 via the second flow path 220 and a shutoff state where no fluid flows from the first flow path 210 to the second outflow port 101Ab2 via the second flow path 220.

The third valve 30A is a flow rate adjustment valve that switches the inflow state of a fluid from a third flow path 230 to a fourth flow path 240. As illustrated in FIG. 8, the third flow path 230 is a flow path that allows a fluid to flow from the second inflow port 101Aa2 to the third outflow port 101Ab3 via the branch position B2.

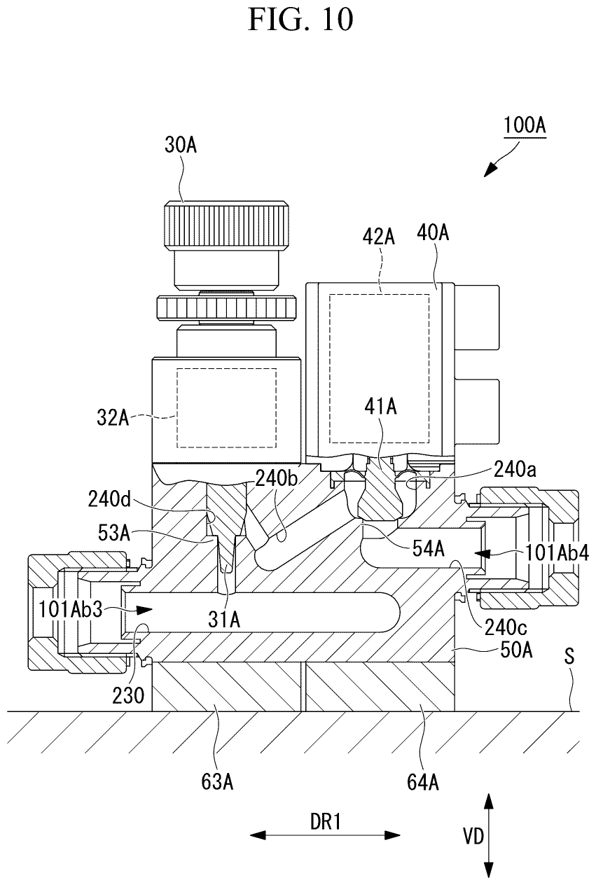

FIG. 10 is an arrow E-E sectional view of the fluid equipment system 100A illustrated in FIG. 7. As illustrated in FIG. 10 and FIG. 11, the third valve 30A has an adjustment mechanism 32A that adjusts the flow rate of a fluid flowing from the third flow path 230 into the fourth flow path 240. The adjustment mechanism 32A causes a valve disc 31A to come close to or separate from a valve seat 53A of the flow path member 50A along the vertical directions VD and thereby adjusts the flow rate of the fluid flowing from the third flow path 230 into the fourth flow path 240.

The fourth valve 40A is a shutoff valve that switches the flow state of a fluid flowing through the fourth flow path 240. As illustrated in FIG. 8, the fourth flow path 240 is a flow path that allows a fluid to flow from the branch position B2 to a fourth outflow port 101Ab4 via the third valve 30A and the fourth valve 40A.

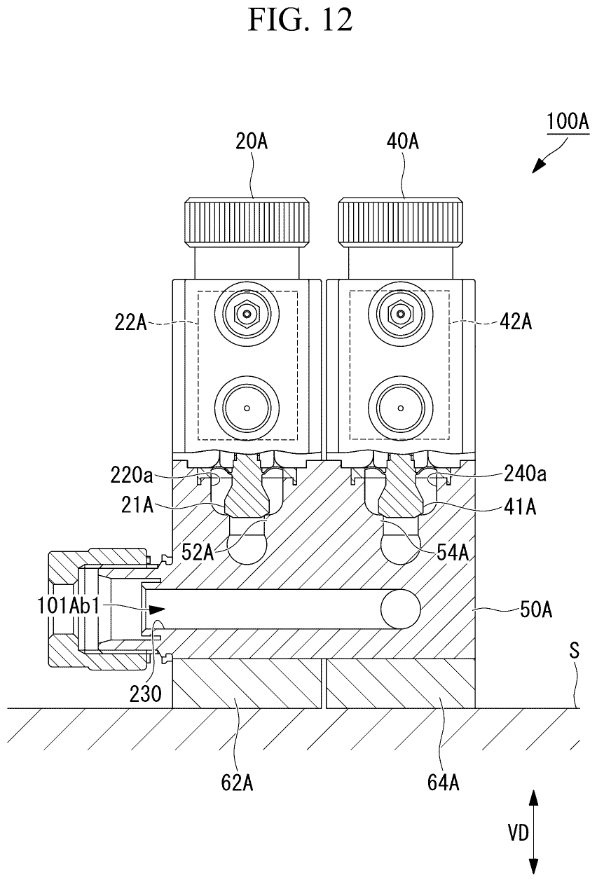

FIG. 12 is an arrow G-G sectional view of the fluid equipment system 100A illustrated in FIG. 7. As illustrated in FIG. 10 and FIG. 12, the fourth valve 40A has a switching mechanism 42A that causes a valve disc 41A to come into contact with or separate from a valve seat 54A of the flow path member 50A along the vertical directions VD and thereby switches the flow state between a flow-through state where a fluid flows from the third flow path 230 to the fourth outflow port 101Ab4 via the fourth flow path 240 and a shutoff state where no fluid flows from the third flow path 230 to the fourth outflow port 101Ab4 via the fourth flow path 240.

The fluid equipment system 100A of the present embodiment causes the first valve 10A to adjust the flow rate of a fluid flowing from the first flow path 210 into the second flow path 220 and causes the second valve 20A to switch whether or not to allow a fluid flowing in from the first inflow port 101Aa1 to flow out of the second outflow port 101b2. Further, the fluid equipment system 100A causes the third valve 30A to adjust the flow rate of a fluid flowing from the third flow path 230 into the fourth flow path 240 and causes the fourth valve 40A to switch whether or not to allow a fluid flowing in from the second inflow port 101Aa2 to flow out of the fourth outflow port 101b4.

The flow path member 50A is a member installed to the installation face S via base members 61A, 62A, 63A, 64A. The flow path member 50A is formed of, for example, a fluoroplastic material. As illustrated in FIG. 9 and FIG. 11, the flow path member 50A is arranged interposed between the base member 61A and the first valve 10A. As illustrated in FIG. 9 and FIG. 12, the flow path member 50A is arranged interposed between the base member 62A and the second valve 20A. As illustrated in FIG. 10 and FIG. 11, the flow path member 50A is arranged interposed between the base member 63A and the third valve 30A. As illustrated in FIG. 10 and FIG. 12, the flow path member 50A is arranged interposed between the base member 64A and the fourth valve 40A.

The base members 61A, 62A, 63A, 64A are fixed to the installation face S by fastening bolts (not illustrated), respectively. Further, the flow path member 50A is fixed to the base members 61A, 62A, 63A, 64A by fastening bolts (not illustrated), respectively.

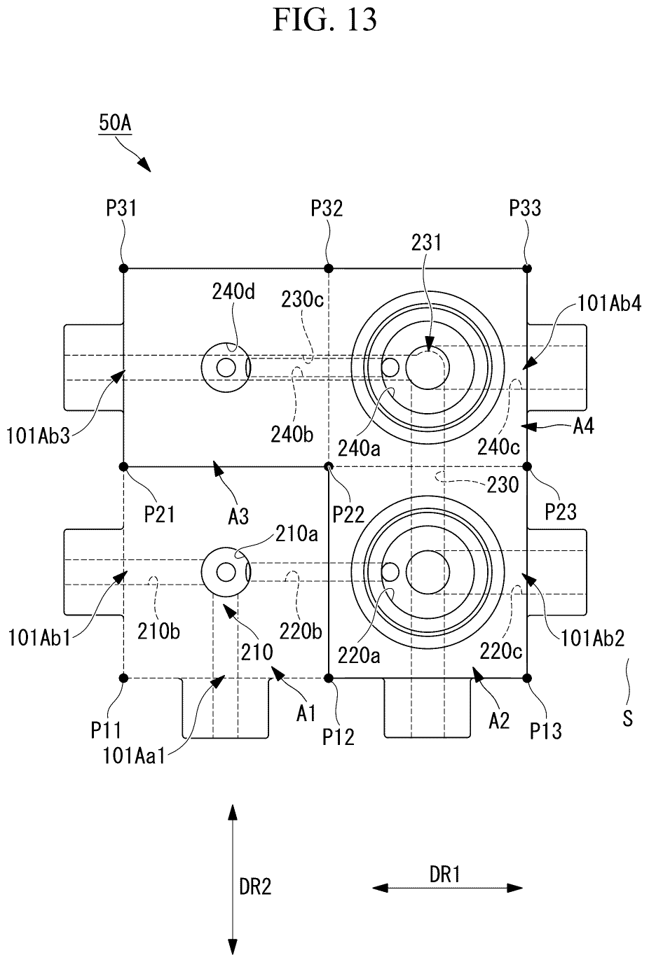

FIG. 13 is a plan view of the flow path member 50A illustrated in FIG. 7. As illustrated in FIG. 13, the flow path member 50A has the first region A1 in which the first valve 10A is installed, the second region A2 in which the second valve 20A is installed, and the third region A3 in which the third valve 30A is installed when the installation face S is viewed in planar view. The first region A1 is a rectangular region having vertexes of position P11, position P12, position P21, and position P22. The second region A2 is a rectangular region having vertexes of position P12, position P13, position P22, and position P23. The third region A3 is a rectangular region having vertexes of position P21, position P22, position P31, and position P32. The fourth region A4 is a rectangular region having vertexes of position P22, position P23, position P32, and position P33.

As illustrated in FIG. 13, the second region A2 is a region that is adjacent to the first region A1 in the first directions DR1 parallel to the installation face S and matches the first region A1 in the second directions DR2 parallel to the installation face S and orthogonal to the first directions DR1. The third region A3 is a region that matches the first region A1 in the first directions DR1 and is adjacent to the first region A1 in the second directions DR2. The fourth region A4 is a region that matches the second region A2 in the first directions DR1 and matches the third region A3 in the second directions DR2.

In the first region A1, the first inflow port 101Aa1 into which a fluid flows and the first outflow port 101Ab1 which allows a fluid flowing in from the first inflow port 101Aa1 to flow out in one direction (the left side in FIG. 13) of the first directions DR1 to outside are formed. In the second region A2, the second inflow port 101Aa2 into which a fluid flows and the second outflow port 101Ab2 which allows a fluid to flow out in the other direction (the right side in FIG. 13) of the first directions DR1 to outside are formed. In the third region A3, the third outflow port 101Ab3 which allows a fluid to flow out in one direction of the first directions DR1 to outside is formed. In the fourth region A4, the fourth outflow port 101Ab4 which allows a fluid to flow out in the other direction of the first directions DR1 to outside is formed.

The first flow path 210 is formed in the first region A1 so that a fluid flowing in from the first inflow port 101Aa1 is guided to the first outflow port 101Ab1. The first flow path 210 has an outflow flow path 210b which allows the first inflow port 101Aa1 and the first outflow port 101Ab1 to communicate with each other.

The second flow path 220 is formed in the first region A1 and the second region A2 so that a fluid flowing in from the first valve 10A is guided to the second outflow port 101Ab2 via the second valve 20A. The second flow path 220 has a valve chest 220a accommodating the valve disc 21A, a connection flow path 220b which allows the valve chest 220a and the valve chest 210a to communicate with each other, and an outflow flow path 220c which allows the valve chest 220a and the second outflow port 101Ab2 to communicate with each other.

The third flow path 230 is formed in the second region A2, the third region A3, and the fourth region A4 so that a fluid flowing in from the second inflow port 101Aa2 is guided to the third outflow port 101Ab3. The third flow path 230 is a flow path which allows the second inflow port 101Aa2 and the third outflow port 101Ab3 to communicate with each other. The third flow path 230 is arranged lower in the vertical direction VD than an outflow flow path 240c of the fourth flow path 240 in the fourth region A4.

The fourth flow path 240 is formed in the third region A3 and the fourth region A4 so that a fluid flowing in from the third valve 30A is guided to the fourth outflow port 101Ab4 via the fourth valve 40A. The fourth flow path 240 has a valve chest 240a accommodating the valve disc 41A, a connection flow path 240b which allows the valve chest 240a and a valve chest 240d to communicate with each other, an outflow flow path 240c which allows the valve chest 240a and the fourth outflow port 101Ab4 to communicate with each other, and a valve chest 240d in which the valve disc 31A of the third valve 30A is accommodated.

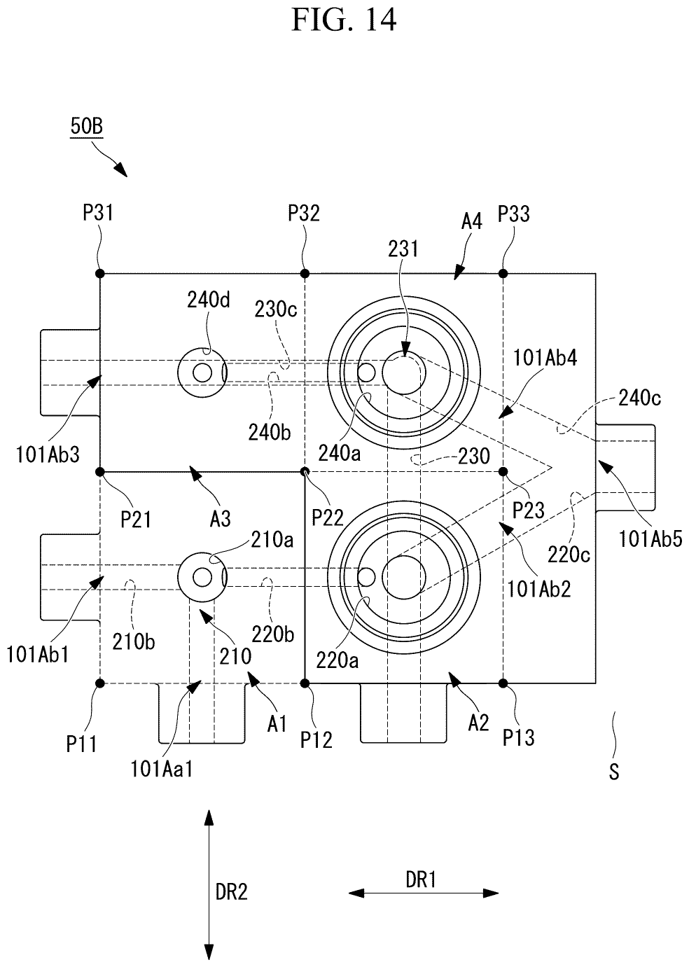

Instead of the flow path member 50A illustrated in FIG. 13, a flow path member 50B of a modified example illustrated in FIG. 14 may be employed. FIG. 14 is a plan view illustrating the modified example as the flow path member 50B for the second embodiment of the present disclosure. The flow path member 50B illustrated in FIG. 14 differs from the flow path member 50A illustrated in FIG. 13 in that fluids flowing out of the second outflow port 101Ab2 and the fourth outflow port 101Ab4 are merged inside and then guided to a single fifth outflow port 101Ab5. By employing the flow path member 50B instead of the flow path member 50A, it is possible to discharge fluids flowing out of the second outflow port 101Ab2 and the fourth outflow port 101Ab4 to outside from the single fifth outflow port 101Ab5.

According to the fluid equipment system 100A of the present embodiment, since the first valve 10A, the second valve 20A, the third valve 30A, and the fourth valve 40A are arranged in adjacent four regions of the first region A1, the second region A2, the third region A3, and the fourth region A4, respectively, the size of the fluid equipment system 100A can be reduced compared to a case where some of these valves are arranged in non-adjacent regions.

Further, according to the fluid equipment system 100A of the present embodiment, a fluid flows out in one direction of the first directions DR1 from the first outflow port 101Ab1 formed in the first region A1 of the flow path member 50A and the third outflow port 101Ab3 formed in the third region A3 of the flow path member 50A, and a fluid flows out in the other direction of the first directions DR1 from the second outflow port 101Ab2 formed in the second region A2 of the flow path member 50A and the fourth outflow port 101Ab4 formed in the fourth region A4 of the flow path member 50A. Respective outflow directions in which the fluids flow out of the flow path member 50A are the first directions DR1 but are divided into one direction and the other direction. Thus, the size of the fluid equipment system 100A can be reduced compared to a case where these outflow directions differ from each other or the outflow occurs only in one direction or the other direction.

What is claimed is:

1. A fluid equipment system comprising:
a flow path member installed to an installation face;
a first valve installed in a first region of the flow path member when the installation face is viewed in planar view and configured to switch a flow state of a fluid flowing through a first flow path;
a second valve installed in a second region of the flow path member when the installation face is viewed in planar view and configured to switch a flow state of a fluid flowing through a second flow path;
a third valve installed in a third region of the flow path member when the installation face is viewed in planar view and configured to switch an inflow state of a fluid from a third flow path into the second flow path; and
fluid equipment configured to supply a fluid to the flow path member,
wherein the second region is a region that matches the first region in first directions parallel to the installation face and is adjacent to the first region in second directions parallel to the installation face and orthogonal to the first directions,
wherein the third region is a region that is adjacent to the second region in the first directions and matches the second region in the second directions,
wherein in the first region,
an inflow port, a fluid flowing from the fluid equipment into the inflow port, and
a first outflow port configured to allow a fluid flowing in from the inflow port to flow out in the first directions to outside are formed,
wherein in the second region,
a second outflow port configured to allow a fluid to flow out in the first directions to outside is formed,
wherein in the third region,
a third outflow port configured to allow a fluid to flow out in the first directions to outside is formed,
wherein the first flow path is formed in the first region so that a fluid flowing in from the inflow port is guided to the first outflow port via the first valve,
wherein the second flow path is formed in the second region and the third region so that a fluid flowing in from the third valve is guided to the second outflow port via the second valve,
wherein the third flow path is formed in the first region, the second region, and the third region so that a fluid flowing in from the first flow path is guided to the third outflow port, and
wherein the inflow port is connected to the fluid equipment and opened to a fourth region that matches the third region in the first directions and matches the first region in the second directions.

2. The fluid equipment system according to claim 1,
wherein the first valve switches the flow state between a first outflow state where a fluid flows from the inflow port to the first outflow port and a first shutoff state where no fluid flows from the inflow port to the first outflow port,
wherein the second valve switches the flow state between a second outflow state where a fluid flows from the third flow path to the second outflow port and a second shutoff state where no fluid flows from the third flow path to the second outflow port, and
wherein the third valve adjusts a flow rate of a fluid flowing from the third flow path into the second flow path in the second outflow state.

3. The fluid equipment system according to claim 1, wherein the third flow path is arranged lower in a vertical direction than the second flow path in the second region.

4. A fluid equipment system comprising:
a flow path member installed to an installation face;
a first valve installed in a first region of the flow path member when the installation face is viewed in planar view and configured to switch an inflow state of a fluid from a first flow path into a second flow path;
a second valve installed in a second region of the flow path member when the installation face is viewed in planar view and configured to switch a flow state of a fluid flowing through the second flow path;
a third valve installed in a third region of the flow path member when the installation face is viewed in planar view and configured to switch an inflow state of a fluid from a third flow path into a fourth flow path; and
a fourth valve installed in a fourth region of the flow path member when the installation face is viewed in planar view and configured to switch a flow state of a fluid flowing through the fourth flow path,
wherein the second region is a region that is adjacent to the first region in first directions parallel to the installation face and matches the first region in second directions parallel to the installation face and orthogonal to the first directions,
wherein the third region is a region that matches the first region in the first directions and is adjacent to the first region in the second directions,
wherein the fourth region is a region that matches the second region in the first directions and matches the third region in the second directions,
wherein in the first region,
a first inflow port, a fluid flowing into the first inflow port, and a first outflow port configured to allow a fluid flowing in from the first inflow port to flow out in one direction of the first directions to outside are formed,
wherein in the second region,
a second inflow port, a fluid flowing into the second inflow port, and a second outflow port configured to allow a fluid to flow out in the other direction of the first directions to outside are formed,
wherein in the third region,
a third outflow port configured to allow a fluid to flow out in the one direction of the first directions to outside is formed,
wherein in the fourth region,
a fourth outflow port configured to allow a fluid to flow out in the other direction of the first directions to outside is formed,
wherein the first flow path is formed in the first region so that a fluid flowing in from the first inflow port is guided to the first outflow port,
wherein the second flow path is formed in the first region and the second region so that a fluid flowing in from the first valve is guided to the second outflow port via the second valve,
wherein the third flow path is formed in the second region, the third region, and the fourth region so that a fluid flowing in from the second inflow port is guided to the third outflow port, and
wherein the fourth flow path is formed in the third region and the fourth region so that a fluid flowing in from the third valve is guided to the fourth outflow port via the fourth valve.

5. The fluid equipment system according to claim 4,
wherein the first valve adjusts the flow rate of a fluid flowing from the first flow path into the second flow path,
wherein the second valve switches the flow state between a state where a fluid flows out of the second outflow port and a state where no fluid flows out of the second outflow port,
wherein the third valve adjusts the flow rate of a fluid flowing from the third flow path into the fourth flow path, and
wherein the fourth valve switches the flow state between a state where a fluid flows out of the fourth outflow port and a state where no fluid flows out of the fourth outflow port.

6. The fluid equipment system according to claim 4, wherein the third flow path is arranged lower in a vertical direction than the fourth flow path in the fourth region.
